(19) United States
(12) Patent Application Publication
(10) Pub. No.: US 2006/0152193 A1
(43) Pub. Date: Jul. 13, 2006

(54) Rechargeable back-up battery pack

(76) Inventor: Chin-Ho Wang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/030,092

(22) Filed: Jan. 7, 2005

(51) Int. Cl. H02J 7/00

(52) U.S. Cl. 320/107

(57) ABSTRACT

A rechargeable back-up battery pack used for supply power to portable devices comprises a case which defines a charger receiving space and a battery receiving space and arranges a DC input port and a power output port. A plurality of first latches are formed on inner side walls of the charger receiving space. Pluralities of rechargeable battery units are placed in the battery receiving space. A cover board is covered on the case to enclose the rechargeable battery units in the case. The cover board forms a locking groove. A charger that has a power input port and a DC output port is placed in the charger receiving space. The charger is provided with a mounting hole and several second latches for engaging with the first latches. A lock component is slidably engaged with the locking groove and separably inserted into the mounting hole to detachably integrate the charger with the case as a unit.

### BACKGROUND OF THE INVENTION

1. Field of the Invention

The present invention relates generally to a rechargeable back-up battery pack, and more particularly to a rechargeable back-up battery pack integrated with a charger.

2. The Related Art

Portable electronic equipments, such as mobile phones, notebooks, digital cameras, etc., are provided power by batteries, so the problem that the portable electronic equipments are frequently broken off resulted from the batteries being used up is more and more notable.

Presently, batteries used in the portable electronic equipments are usually rechargeable, such as lithium battery, Nickel-metal-hydride battery and the like. Therefore, when users stay out, additional chargers must be taken with them for charging the batteries, which brings many inconveniences to users.

In order to solve the above problem, a kind of back-up battery that integrates a charger with the rechargeable battery was made up. This kind of battery has an insulating shell. The charger and the rechargeable battery are enclosed in the shell. The charger can automatically charge the rechargeable battery at once when the battery is exhausted, and this product is easy to carry.

However, there is a potential fatal danger during the back-up battery operating. For the reason that the back-up battery encloses the charger and the rechargeable battery in the insulating shell, and both the charger and the rechargeable battery produce a lot of calorific power during charging, therefore, the calorific power accumulated by the charger and the rechargeable battery will result in that the product can't work stably. Moreover, under some extreme conditions, the accumulated calorific power will cause the rechargeable battery exploding.

### SUMMARY OF THE INVENTION

An object of the present invention is to provide a rechargeable back-up battery pack in which a charger is detachably integrated as a unit for facilitating carrying and to ensure the work of charging safely and stably.

In order to achieve the above object, the present invention provides a battery pack comprising:
a case, a charger receiving space and a battery receiving space being defined in the case, a DC input port and a power output port being arranged in outer side of the case;
at least one rechargeable battery unit placed in the battery receiving space;
a cover board covered on the case to enclose the rechargeable battery unit in the case, a locking groove being defined in the cover board;
a charger received in the charger receiving space, the charger having a power input port and a DC output port and defining a mounting hole in a side wall thereof; and
at least a lock component slidably engaged with the locking groove and separably inserted into the mounting hole to detachably integrate the charger with the case as a unit.

In order to achieve the above object, the present invention provides a battery pack comprising:
a case, a charger receiving space and a battery receiving space being defined in the case, a DC input port and a power output port being arranged in outer side of the case, a plurality of first latches being formed on inner side walls of the charger receiving space;
at least one rechargeable battery unit placed in the battery receiving space;
a cover board covered on the case to enclose the rechargeable battery unit in the case; and
a charger received in the charger receiving space, the charger having a power input port and a DC output port, a plurality of second latches being formed on side walls of the charger;
wherein the first latches engages with the second latches to detachably integrate the charger with the case as a unit.

As described above, the rechargeable back-up battery pack detachably integrates the charger therein, therefore, the charger can be taken out during charging to ensure the work of charging safely and stably, while the charger is not in need, the charger can be integrated with the battery pack as a unit for facilitating carrying.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a rechargeable back-up battery pack according to the present invention.

FIG. 2 is an assembled, perspective view of the rechargeable back-up battery pack.

FIG. 3 is a perspective view of the rechargeable back-up battery pack in the state of charging.

FIG. 4 is a perspective view of a charger of the rechargeable back-up battery pack.

FIG. 5 is a perspective view of a lock component of the rechargeable back-up battery pack.

### DETAILED DESCRIPTION OF THE PREFERRED EMBODIMENT

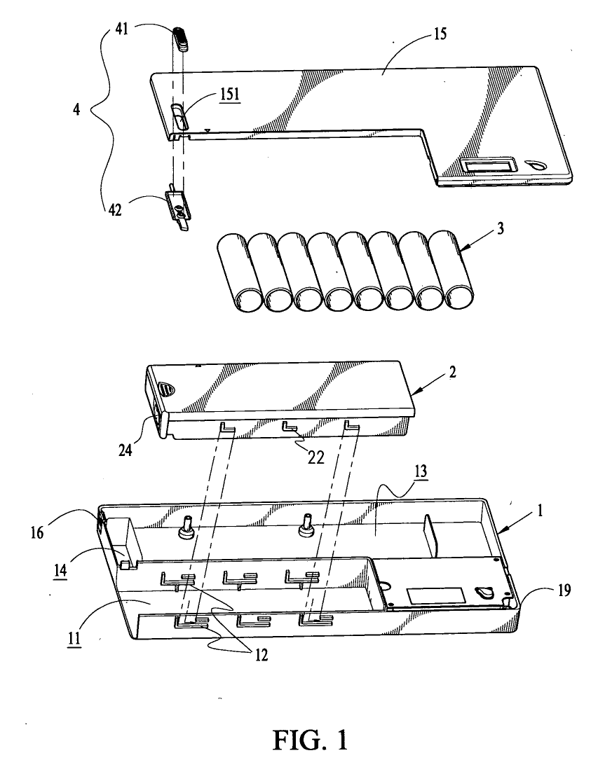

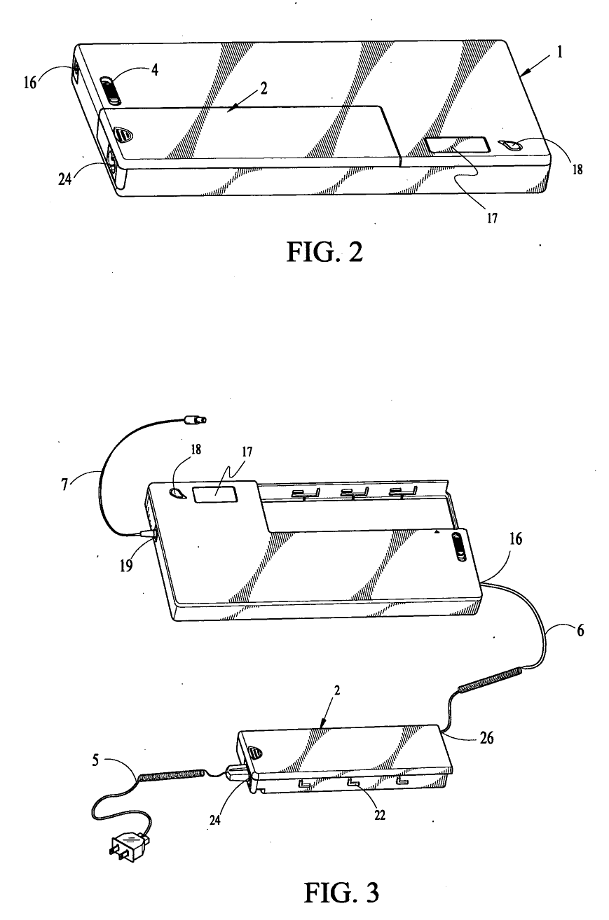

Please refer to FIG. 1 and FIG. 2, which show a preferred embodiment of a rechargeable back-up battery pack according to the present invention. The battery pack comprises a case 1, a cover board 15, a charger 2, a plurality of rechargeable battery units 3 and a lock component 4.

The case 1 defines a charger receiving space 11 in one side thereof and a battery receiving space 13 in the other side thereof. The charger receiving space 11 is used for containing the charger 3, and the battery receiving space 13 is used for receiving pluralities of rechargeable battery units 3. These rechargeable battery units 3 are connected in parallel or in series to supply the portable electronic equipment desired power. In this embodiment, the rechargeable battery unit 3 is lithium-ion battery. The rechargeable battery unit 3 can also be embodied by Nickel-metal-hydride battery, Nickel-Cadmium battery and so on. The case 1 further defines a slider receiving space 14 in one end of the battery receiving space 13. The charger receiving space 11 is approximately shaped as rectangle. A plurality of first latches 12 are formed on two inner side walls of the charger receiving space 11.

The case 1 places a DC (Direct Current) input port 16 in one end thereof and a power output port 19 in the other end thereof. The DC input port 16 is used for accepting charging current supplied from the charger 2, and the power output port 19 is used for supplying the portable equipment with working power.

The case 1 is equipped with a power inspect circuit which is used for inspecting and displaying the rest power stored in the rechargeable battery units 3. If users want to acquire the information of the rest power, the users can press a button 18, then a LCD panel 17 would display the information of the rest power stored in the rechargeable battery units 3. Since the power inspect circuit is well known to those skilled in the art, a detailed description thereof is omitted herein.

The cover board 15 covers on the case 1 so as to enclose the rechargeable battery units 3, the power inspect circuit, the button 18, and the LCD panel 17 into the case 1. The cover board 15 forms a locking groove 151 in one side thereof so as to slidably contain the lock component 4.

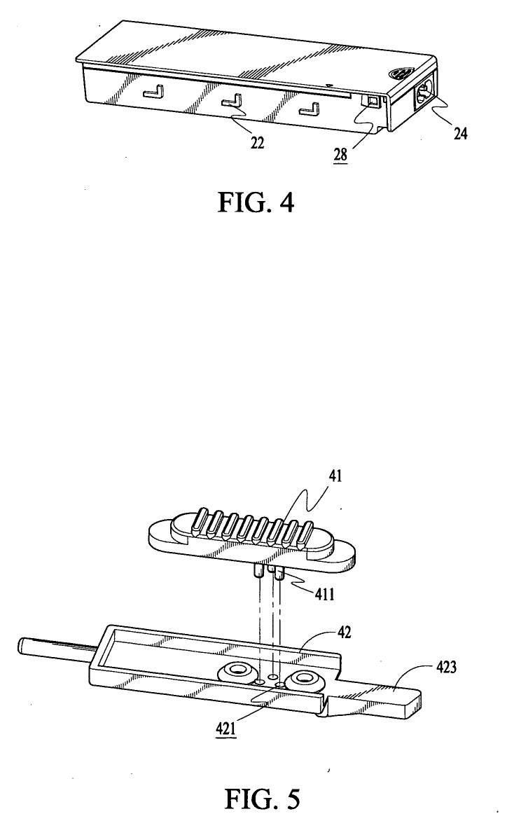

The charger 2 is equipped with charging circuit so as to supply charging current for the rechargeable battery units 3. Since the charging circuit is well known to those skilled in the art, a detailed description thereof is omitted herein. The charger 3 disposes a power input port 24 on one end thereof and a DC output port 26 on the other end thereof (referring to FIG. 3). The power input port 24 accepts outside alternating current, and the DC output port 26 exports DC current transferred by the charging circuit. The charger 2 arranges several second latches 22 on two opposite sidewalls thereof corresponding to the first latches 12. The second latches 22 and the first latches 12 are engaged with each other. The charger 2 disposes a mounting hole 28 (referring to FIG. 4) in one of the side wall near the power input port 24 so as to engage with the lock component 4.

Please refer to FIG. 5, the lock component 4 comprises a push rod 41 and a slider 42. The push rod 41 which disposes several connecting poles 411 on bottom thereof is slidably placed in the locking groove 151. The slider 42 is received in the slider receiving space 14. The slider 42 is provided with a protruding portion 423 on one end thereof and several connecting holes 421 in the middle thereof corresponding to the several connecting poles 411. The connecting poles 411 pass through the locking groove 151 and insert into the connecting holes 421 to assemble the push rod 41 and the slider 42.

Please refer to FIG. 3, the present battery pack cooperates with an input line 5, a connect line 6 and an output line 7 during operating. When users charge the rechargeable battery units 3, the outside alternating current is transmitted into the charger 2 through the input line 5 and the power input port 24. After rectified and transformed by the charger 2, the charging current is supplied for the rechargeable battery units 3 through the DC output port 26, the connect line 6 and the DC input port 16. While the rechargeable battery units 3 are being charged or after have been charged completely, the working power supplied by the rechargeable battery units 3 is transmitted into the portable equipment through the power output port 19 and the output line 7.

After finished charging, the charger 2 can be received and fastened in the charger receiving space 11 of the case 1 by engaging the second latches 22 of the charger 2 with the first latches 12 of the case 1. The process of assembling the charger 2 and the case 1 is firstly aligning the second latches 22 with openings of the first latches 12, secondly pushing the charger 2 down till the charger 2 cannot be pushed, finally pushing the charger 2 along a direction indicated by an arrow shown in FIG. 1.

Furthermore, in order to prevent the charger 2 from sliding out from the case 1, the users can push the push rod 41 of the lock component 4 to slide the slider 42, thereby projecting the protruding portion 423 of the slider 42 into the mounting hole 28 to restrict the charger 2 moving.

When the battery pack need to be recharged, the users push the push rod 41 reversely so as to disengage the protruding portion 423 from the mounting hole 28, then moves the charger 2 upwardly to take the charger 2 away from the case 1. Then the charger 2 is connected to outside AC and the DC input port 16 by line 5 and line 6 respectively so as to charge the rechargeable battery units 3 as described above.

As described above, the present rechargeable back-up battery pack detachably integrates the charger 2 therein, therefore, the charger 2 can be taken out during charging to ensure the work charging safely and stably, while the charger 2 is not in need, the charger 2 can be integrated with the battery pack as a unit for facilitating carrying.

This invention has been described with reference to a specific embodiment. This description is not to be construed in a limiting sense. For example, those skilled in the art will recognize modifications and alterations that may be made to the embodiment illustrated herein. However, it is contemplated that such modifications can be made without departing the scope and spirit of the invention as defined in the following claims. For example, to change the amount and the shape of the first latch and the second latch should be the claim scope of the present invention.

What is claimed is:

1. A rechargeable back-up battery pack comprising:
a case, a charger receiving space and a battery receiving space being defined in the case, a DC input port and a power output port being arranged in outer side of the case;
at least one rechargeable battery unit placed in the battery receiving space;
a cover board covered on the case to enclose the rechargeable battery unit in the case, a locking groove being defined in the cover board;
a charger received in the charger receiving space, the charger having a power input port and a DC output port and defining a mounting hole in a side wall thereof; and
at least a lock component slidably engaged with the locking groove and separably inserted into the mounting hole to detachably integrate the charger with the case as a unit.

2. The battery pack as claimed in claim 1, wherein said lock component comprises a push rod and a slider, and the slider has a protruding portion on one end thereof for inserting into the mounting hole.

3. The battery pack as claimed in claim 1, wherein a plurality of first latches are formed on inner side walls of the charger receiving space, while the charger arranges a plurality of second latches on side walls thereof for engaging with the first latches.

4. A rechargeable back-up battery pack comprising:
a case, a charger receiving space and a battery receiving space being defined in the case, a DC input port and a power output port being arranged in outer side of the case, a plurality of first latches being formed on inner side walls of the charger receiving space;
at least one rechargeable battery unit placed in the battery receiving space;
a cover board covered on the case to enclose the rechargeable battery unit in the case; and
a charger received in the charger receiving space, the charger having a power input port and a DC output port, a plurality of second latches being formed on side walls of the charger;
wherein the first latches engages with the second latches to detachably integrate the charger with the case as a unit.

5. The battery pack as claimed in claim 4, wherein said cover board defines a locking groove, and said charger defines a mounting hole in a side wall thereof, and the battery pack further comprises a lock component slidably engaged with the locking groove and separably inserted into the mounting hole.

6. The battery pack as claimed in claim 5, wherein said lock component comprises a push rod and a slider, and the slider has a protruding portion on one end thereof for inserting into the mounting hole.
